(19) United States
(12) Patent Application Publication
(10) Pub. No.: US 2016/0189195 A1
(43) Pub. Date: Jun. 30, 2016

(54) Method and System for Providing Benefits to Retail Consumers

(71) Applicant: Sears Brands, L.L.C., Hoffman Estates, IL (US)

(72) Inventors: Barbara Rae Ryan, Chicago, IL (US); Gary A. Van Prooyen, Wheaton, IL (US)

(21) Appl. No.: 14/928,460

(22) Filed: Oct. 30, 2015

Related U.S. Application Data
(63) Continuation of application No. 10/659,228, filed on Sep. 10, 2003, now abandoned.

(51) Int. Cl. G06Q 30/02

(52) U.S. Cl. CPC G06Q 30/0226

(57) ABSTRACT

A retail store develops a marketing incentive program and distributes different types of benefits to consumers in the program. One benefit the retail store can distribute is a recurring cash value benefit to the consumer.

### FIELD OF THE INVENTION

The invention generally relates to marketing and customer loyalty programs. Specifically, the invention relates to a method and apparatus for identifying retail consumers and providing benefits to the retail consumers.

### BACKGROUND OF THE INVENTION

The competition to attract consumers in the retail industry is substantial. Consumers have increasingly more choices in the variety of goods and services available, and how and where to make goods and services purchases. In addition, the proliferation of advertising materials and Internet sites have made price comparisons easier for consumers.

Over the years, manufacturers and retailers have used various methods to entice consumers to shop at and return to their store to purchase their products or services. Many retailers offer clubs or on-going rewards or loyalty programs to encourage consumers to return to the retailer to purchase goods or services. Research conducted by McKinsey & Company indicated that about half of the ten largest U.S. retailers in each of seven sectors have launched loyalty programs. Cigiliano, James et al., The Price of Loyalty, The McKinsey Quarterly 2000 No. 4, p. 68. According to the research, 48% out of 53% of consumers that enrolled in a grocery loyalty program spend more than they would have without enrollment in the program. Id.

Clubs and on-going rewards or loyalty programs offer a combination of hard benefits, i.e., the accumulation of points, discount certificates, and other rewards, and soft benefits, i.e., recognition and preferential treatment. Consumers sign-up for the clubs and on-going rewards or loyalty programs to receive the benefits advertised and to feel like they are getting “something back” from the retailer when they purchase goods or services. After the consumer becomes a member of a club or program, they begin to receive the hard and soft benefits offered by the club or program. The hard benefits are received and are based on the amount of the consumers' purchases. For example, a consumer spends $450.00 at a local retailer and receives 450 reward points or 1% cash back for the purchase. Or, if the consumer spends a certain amount at a local retailer they receive a percentage off discount certificate for a future purchase.

### SUMMARY OF THE INVENTION

Accordingly, there is a need for an improved method and system of providing marketing incentives to consumers to maintain consumer loyalty. To achieve loyalty toward a retailer, prospective and current consumers receive an expected and recurring incentive that can be used toward the purchase of products and services regardless of past purchase history.

In some embodiments, the invention includes a method of providing a benefit to consumers. The method comprises the acts of selecting a plurality of consumers and distributing a recurring cash value benefit to the plurality of consumers.

In some embodiments, the invention includes a method of determining the effectiveness of a marketing incentive. The method comprises the acts of selecting a plurality of consumers; selecting a first subset of the plurality of consumers and providing an incentive in the form of a recurring cash value benefit to the consumers in the first subset; selecting a second subset of the plurality of consumers and providing an incentive different than the recurring cash value benefit to the consumers in the second subset; and analyzing, after a predetermined amount of time, a behavior of the consumers in the first and second subsets to determine which incentive is effective.

In some embodiments, the invention includes a method for a retail store to treat a consumer like an employee. The method comprises the acts of selecting the consumer; informing the consumer that they are being provided a benefit similar to a benefit received by an employee; and distributing a recurring cash value benefit to the consumer without consideration of the amount of the consumer's spending at the retail store.

Additional independent objects and independent features of the invention are provided in the subsequent disclosure.

### BRIEF DESCRIPTION OF THE DRAWINGS

FIG. 1 illustrates an exemplary cash value benefit.

### DETAILED DESCRIPTION

Before embodiments of the invention are explained in detail, it is to be understood that the invention is not limited in its application to the details of the examples set forth in the following description or illustrated in the drawings. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. The terms “mounted,” “connected,” and “coupled” are used broadly and encompass both direct and indirect mounting, connecting, and coupling. Further, “connected” and “coupled” are not restricted to physical or mechanical connections or couplings.

It should be noted that the invention is not limited to any particular software language described or implied in the figures. One of skill in the art will understand that a variety of alternative software languages may be used for implementation of the invention. It should also be understood that some components and items are illustrated and described as if they were hardware elements, as is common practice within the art. However, one of ordinary skill in the art, and based on a reading of this detailed description, would understand that, in at least one embodiment, components in the method and system may be implemented in software or hardware.

A retail store hires employees to run and manage the store's day-to-day operations. The retail store also hires employees that are specially trained in particular areas such as marketing, product branding, research and development, etc. The employees hired to perform marketing and product branding tasks are generally responsible for, among other things, presenting marketing programs and incentives to consumers to bring new and/or existing consumers into the retail store. One goal of the retail store and the employees is to develop techniques that will attract consumers into the retail store to buy goods or services. It is also a goal of the retail store and the employees to lure consumers away from other competitor retail stores. Along with attracting consumers into the retail store, marketing employees develop programs and incentives to retain loyal and valued customers.

There are many ways that the retail store can communicate with consumers to try to get them into their store. One technique is to formulate and generate advertisements announcing sales on merchandise and arrivals of new merchandise. The advertisements can be distributed through daily or weekly newspapers and magazines or through direct mail campaigns that target certain consumers based on demographics. Advertisements can be broadcast on radio, television, and the Internet.

In some embodiments, the present invention is a marketing incentive program for a retail store to communicate with consumers. The retail store identifies a plurality of consumers to participate in the program. The retail store may select all or less than all of the consumers to participate in the program. The retail store may invite or inform the selected consumers of the program and the consumers may or may not elect to participate.

The consumers can be selected by a variety of methods. The consumers can be selected based on their value to the retail store or can be randomly selected. In some embodiments, the consumers that are selected to participate in the program are most-valued consumers. A most-valued consumer can be someone who appears to appreciate the retail store and has shopped regularly over many years.

In some embodiments, the most-valued consumers can be identified based on at least one criterion. The criterion can vary depending on the importance it has relative to the retail store. For example, the criterion can include, but is not limited to, the highest revenue matched with the highest profit percentage, the consumer's gross merchandise purchases, the retail store's gross profit margin on the consumer's purchases, the consumer's method of payment for purchases, e.g., does the consumer hold the retail store's credit card, the consumer's number of trips to the retail store, the consumer's participation in the retail store's clubs, the number of product categories the consumer has shopped, the number of the retail store's divisions the consumer has shopped, the consumer's net softlines and hardlines purchases, the number of maintenance agreements the consumer has purchased, percentage of regular and promised discounts taken relative to the consumer's regular priced purchases, and the consumer's demographics, e.g., age, income, number of children, whether a homeowner, type of residence, and length of residency. Of course, other criteria and demographics categories can be considered in identifying the most-valued consumers.

In some embodiments, the most-valued consumers can be identified based on a mathematical algorithm that takes into consideration at least one of the above criteria. The mathematical algorithm can be any standard or customized algorithm used in marketing or business analyses. Each criterion is assigned a numerical value that is input to the mathematical algorithm. The output is a numerical value for each consumer. The numerical value ranks each consumer relative to other consumers. The retail store identifies a most-valued numerical range, and the consumers within the range are identified as the most-valued consumers. For example, the consumers that ranked within the top 10% of all consumers are identified as the most-valued consumers.

In identifying the most-valued consumers, the selected most-valued consumer group can be categorized based on the selected criterion or criteria. The group of most-valued consumers can be categorized into consistently active, returning active, newly active, and newly inactive. The consistently active most-valued consumer group includes consumers with trackable shopping for the most recent twelve months and in at least two of the past four years. The returning active most-valued consumer group includes consumers with trackable shopping in the first year and in the most recent twelve months with no shopping the second and third years of the past four years. The newly active most-valued consumer group includes consumers with trackable shopping in the most recent twelve months without any shopping record prior to the most recent twelve months. The newly inactive most-valued consumer group includes consumers with no trackable shopping for the most recent twelve months but prior shopping in any of the prior three out of the past four years.

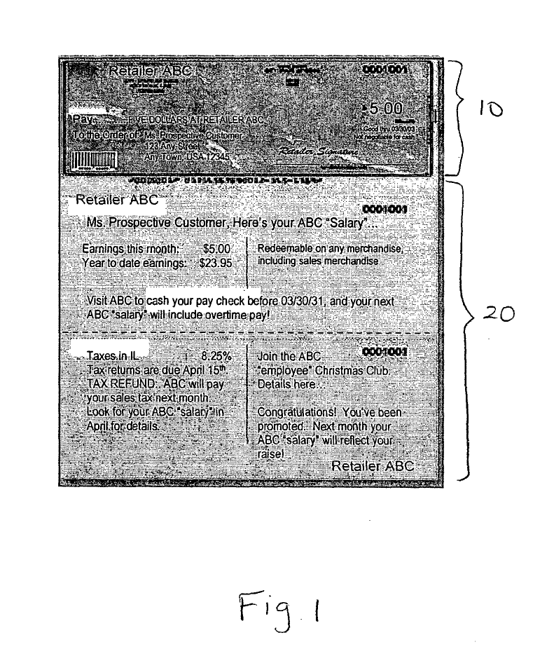

As part of the marketing incentive program, the retail store can provide many different types of benefits to the consumers in the program. For example, the retail store can distribute a recurring cash value benefit to the consumer. The recurring cash value benefit, illustrated in FIG. 1, is distributed to the consumer regardless of shopping/spending habits. The consumer can expect to receive the cash value benefit on a periodic basis. The cash value benefit can have an expiration date.

The recurring cash value benefit can be in the form of cash, a check, a negotiable instrument, a coupon, a voucher, a rebate, a redemption certificate, a gift certificate, or any other similar document or instrument that reflect a cash value. The cash value benefit can be distributed to all of the consumers or a selected group of the consumers in the program. The cash value benefit can be the same or a different amount for each consumer. The recurrence of the cash value benefit can vary for each consumer. For example, the cash value benefit can be distributed monthly to some consumers and quarterly to other consumers. The amount of the cash value benefit can increase or decrease depending on a variety of factors. For example, the amount of the cash value benefit can increase during the holidays or any other time of year. The amount of the cash value benefit can also vary depending on the consumer's pattern of spending, the amount of previous purchases, or in response to a survey indicating that the consumer expects to purchase certain items in the future.

The cash value benefit can be used to purchase products and services at the retail store. The cash value benefit can also be used to purchase products and services at other retail stores that recognize and/or accept the benefit.

The benefits of the marketing incentive program can also be distributed over the Internet and via electronic mail messaging. Some consumers may prefer and can elect to receive electronic benefits instead of traditional paper benefits. The benefits can be used on the Internet or can be printed and used at the brick-and-mortar retail store.

In some embodiments of the marketing incentive program, the retail store can provide other benefits that can include issuance of an identification card, no hassle, no-receipt returns/exchanges, flashback pricing, free delivery and set-up, price guarantee, buy-at-cost events, random checkout discounts, personal sales days, free companion products, product upgrade coupons, family and friend savings coupons, priority in-home service, enhanced purchase protection, extended purchase protection, find-it service, and stock options.

The issuance of an identification card benefit allows access to other benefits. The identification card can include the consumer's photograph, name, address, telephone number, a barcode, a magnetic stripe with encoded data or unique identification number, start date in the program, and other data as desired. The consumer can receive and/or access additional benefits by showing/displaying the identification card.

The no hassle, no-receipt returns/exchanges benefit provides the convenience of not having to maintain the retail store's receipts. At the time of return or exchange, the consumer presents an identification card indicating the consumer's participation in the program. The retail store maintains a record of all purchases and the consumer is assured that they will receive the exact price paid for the item upon return or exchange.

The flashback pricing benefit allows the consumer to purchase merchandise at a price that the retail store charged in the past. The retail store can inform the consumer of the merchandise that is available at the special pricing in advance. For example, the retail store can inform the consumer that Levi® jeans can be purchased at the 1978 price of $9.00.

The free delivery and set-up benefit provides the consumer with free standard delivery and set-up for any major appliance, mattress, lawn and garden, electronics, home improvement purchase, or other purchases that may require delivery and/or set-up. The retail store can also offer to haul away any old items.

The price guarantee benefit provides price matching plus an additional percentage, e.g., 10%, of the difference. The consumer presents information of the lower price at a different retail store to a sales associate at the time of purchase or within a predetermined period of time, e.g., 30 days, after the purchase to receive the price guarantee.

The buy-at-cost events benefit provides the consumer with the option to purchase items at cost or wholesale price at certain times throughout the year. The retail store can inform the consumer and provide notice of the selected items available in advance of the special pricing event.

The random checkout discounts benefit provides the consumer with a surprise bonus that is automatically applied to the sales transaction total at the register. The surprise bonus can be a percentage off the total sales transaction, a free item, or a percentage off one item. The random checkout discount benefit can also provide the consumer with a surprise bonus that is redeemable on the consumer's next purchase at the retail store. The consumer receives the surprise bonus upon presentation of the identification card indicating the consumer's participation in the program.

The personal sales day benefit provides the consumer the option of selecting a predetermined number of shopping days and receiving a specified discount on all items purchased on those days. For example, the consumer can select up to four shopping days in a year in which to receive a 10% discount on all items purchased on those days. The discount can be applied to items already on sale.

The free companion products benefit provides the consumer a bonus offer for free companion products or accessories that go along with a particular purchase. For example, the consumer can receive a set of free wash cloths with the purchase of a set of bath towels, or a free toolbox with the purchase of a particular tool.

The product upgrade coupons benefit provides the consumer with a booklet of coupons that can be redeemed for the next highest available product at no additional cost. For example, the consumer can purchase a 22″ television for the price of a 19″ television, or goose down pillows for the same price as fiber fill pillows.

The family and friends savings coupons benefit allows the consumer to share the program benefits with family and friends. The consumer is provided with a plurality of coupons that can be distributed to family and friends to use on purchases made in a day or on single items. This benefit can also provide the consumer with coupons for personal use. The coupons can be used to purchase items already on sale.

The priority in-home service benefit provides the consumer with priority scheduling when an in-home service appointment is requested. The consumer can be offered extended service times, including evening and weekend hours and a specified window for arrival time.

The enhanced purchase protection benefit is an enhancement to an extended warranty plan purchased by the consumer. For example, the consumer can receive a free annual preventive maintenance check for the life of the extended warranty plan.

The extended purchase protection benefit is a free extension to an extended warranty plan purchased by the consumer. For example, the consumer receives a six month extension to a three year extended warranty plan, or a one year extension to a five year extended warranty plan.

The find-it service benefit finds an item that is not in stock and holds it for pick up at the nearest retail store location. In addition, the item can be shipped to the consumer at no additional cost.

The stock options benefit distributes to the consumer a cash back amount in the form of the retail store's stock certificates or proportional shares in a mutual fund. The retail store tracks the amount of the consumer's spending and at the end of the year (or other time) distributes the stock certificates in an amount proportional to the amount of the consumer's purchases. The consumer can choose to keep the stock certificates for investment purposes or convert to cash by selling the shares at the current trading price.

In some embodiments, the marketing incentive program can include additional or different benefits than described above that provide and/or are similar to employee type benefits. In these embodiments, the retail store provides benefits to its consumers that are similar to the benefits that employees of the retail store may receive. For example, the recurring cash value benefit, illustrated in FIG. 1, is similar to an employee recurring paycheck. The cash value benefit can be distributed to the consumer in the form of a paycheck 10. The paycheck 10 can include a pay stub portion 20 that announces new benefits or indicates the status of the consumer's participation in the program.

Additional marketing incentive program benefits can include promotion announcements that increase the amount and/or frequency of benefits, bonus pay, participation in surveys, invitations to special events, advanced notice of store changes and/or new merchandise, opportunity to purchase merchandise and services before the general public, opportunity to shop outside normal store hours, vacation time, maternity benefits, opportunity to join private clubs, receipt of year-end statement, commuter benefit, participation in sales incentive plans, stock purchase promotions, receipt of company newsletters, and participation in a company “match” program.

The promotion announcements related to an increase in the amount and/or frequency of benefits rewards the consumer for increased spending at the retail store. The consumer's amount and/or frequency of benefits can also be increased to motivate more visits to the retail store or amount of spending. The benefits promotion announcement can be related to employee job titles at the retail store. For example, when an employee is promoted from manager to vice president, the promotion is typically accompanied with a pay raise. Similarly, in the incentive program, a consumer can be provided with an honorary title such as manager and receive benefits similar to a manager level. Upon promotion to the honorary vice president level, the consumer receives an increase in the amount and/or frequency of benefits received.

The bonus pay benefit provides the consumer with a cash value benefit in addition to the recurring cash value benefit. The bonus pay cash value benefit can be awarded based on several factors. The factors can include, but are not limited to the length of time in the program, reaching a particular spend level, or purchasing an item(s) in a particular department. The bonus pay benefit can be used as a reward to motivate current and future behavior, to promote store events, and to test responses and behaviors to promotions.

The participation in surveys benefit can provide feedback to the retail store in determining desirable merchandise and/or new products to include in the retail store, convenient store layouts, future marketing incentives or loyalty programs, future benefits that will motivate certain behaviors, and the consumer's future spending habits. The consumer can also make special requests for unique merchandise or brands to include in the retail store or make available on-line through an e-commerce web site. The survey can be similar to an employee survey or suggestion box. The consumer can be rewarded with bonus pay for participation.

The invitations to special events benefit includes consumers in employee-type events, such as company picnics, holiday celebrations, pre-sales events, consumer loyalty events, or any other celebration typically attended only by employees and/or their spouses/significant others. The invitations can be sent to select consumers or all consumers in the program. For example, invitations can be sent to the consumers that have spent the highest amount within in a certain time period. Invitations can be sent to select consumers to celebrate certain milestones in the program, such as length of time in the program (similar to celebrating employee anniversaries). The invite to employee or consumer celebrations can be a motivating factor to encourage additional spending in the retail store.

The advanced notice of sales, store changes, and/or new merchandise benefit allows the consumer to prepare and be aware of new locations for merchandise during their next retail store visit. The notice of new merchandise announces the introduction of new lines of merchandise, new brands, or the arrival of seasonal merchandise. The advance notice of sales at the retail store allows the consumer to plan ahead and to prevent purchasing merchandise at full price just before the sale.

The opportunity to purchase merchandise and services before the general public benefit allows the consumer, similar to the benefit that employees receive, to view new merchandise or seasonal merchandise before the general public. The consumer has a better selection to choose from before the general public is given the opportunity to purchase the merchandise.

The opportunity to shop outside normal store hours benefit can also be known as a “private shopping day.” The consumer can be invited to purchase merchandise at specified times when the general public cannot shop. This benefit allows the consumer to avoid crowds and can be treated to other complimentary amenities while shopping, such as valet parking, coat rental, storage for purchased merchandise to continue shopping, snacks, and beverages.

The vacation time benefit provides the consumer with chances to receive free vacations, merchandise, and bonus cash value benefits. The cash value benefits can be distributed during popular vacation times to use toward merchandise that can be used during vacations, e.g., swimsuits, barbecue grills, beach umbrellas, and picnic baskets. The cash value benefits can also be distributed to the consumer to use while on vacation, e.g., gasoline coupons, hotel discounts, and theme park discounts.

The maternity benefits provides expecting couples or persons engaged in the adoption process a cash value benefit that can be used to purchase baby-related merchandise, e.g., cribs, strollers, layettes, clothes, and toys or maternity-related merchandise, e.g., books and clothes. In addition, friends and family can receive cash value benefits to purchase baby-related merchandise. The consumer can also be invited to special events to celebrate the parents-to-be and/or the new baby.

The opportunity to join private clubs benefit provides the consumer with special privileges and cash value benefits. Joining a club can provide special discounts and announcements for merchandise related to the club. The consumer can be randomly selected to be invited to a particular club or can be reward based. In addition, the consumer can be given the opportunity to “bank” the cash value benefits, which extends the expiration date such that multiple cash value benefits can be used to purchase merchandise. For example, the consumer receives a $10.00 cash value benefit for six consecutive months. Each cash value benefit would normally expire at the end of the month, however, the “bank” option allows the consumer to save the cash value benefits and use them during the sixth month to save $60.00 on purchases.

The year-end statement benefit provides a summary, similar to an IRS W-2 form distributed to employees, of the cash value benefits received throughout the year. The year-end statement can be categorized into the different types of benefits received by the consumer. The year-end statement can also include the amount of money spent in the retail store and can categorize the merchandise to show in what departments the money was spent in relation to the cash value benefits received.

The commuter benefit provides cash value benefits to the consumer for auto-related costs due to travel to and from the store. These benefits are similar to the rebates, coupons, or savings employees may receive from their employer for public transportation costs to work. The consumer can receive cash value benefits for oil changes, tires, tune ups, etc.

The participation in sales incentive plans benefit provides the consumer with a cash value benefit for reaching a specific goal, such as spending a minimum amount on merchandise or services in the retail in one visit, over a predetermined number of visits, or within a particular department (e.g., jewelry). This benefit is similar to an employer rewarding employees for reaching company sales, quality, or shipping goals. Consumers that reach the goal can also be entered into a drawing or sweepstakes for a special prize.

The stock purchase promotions benefit is an incentive to the consumer to continue shopping and spending money at the retail store. This benefit is similar to employers giving employees stock options as an incentive to stay with the company or as a reward for good performance or for achieving unexpected results. For example, the consumer can receive a cash value benefit that is equal to one share of the retail store's current stock price for achieving spending goals, length of time in the program, or other specified goals.

The receipt of company newsletters benefit informs the consumer about day-to-day activities at the company/retail store. The newsletter can include information about new employees, such as sales associates, managers, or customer service representatives, or new merchandise, upcoming sales, or any other information that is of interest to the consumer.

The participation in a company “match” program benefit provides the consumer with a cash value benefit similar to “buy one get one free.” This is similar to an employer matching employee deposits in a stock or savings plan. The consumer can receive a cash value benefit to receive two items for the price of one.

The benefits of the marketing incentive program are not limited to the benefits listed and described above. The benefits described above can encompass additional details not specifically mentioned, but are within the scope of the invention. Other benefits not specifically described above are also within the scope of the invention.

In some embodiments, the invention determines the effectiveness of a marketing incentive. The retail store selects consumers by random, from the most-valued group, or by any other method to participate in a marketing program. The consumers are separated, either randomly or selectively, into a plurality of groups, e.g., two groups. The retail store can provide a different benefit to each group and study the behaviors of each group and how the particular benefit affects the consumer's behavior. Some benefits may be more attractive to certain consumers and influence spending decisions. Other benefits may not have any affect on the consumer's behavior. The retail store can analyze the results of the benefit on certain behaviors and can create future marketing incentive programs to obtain desirable outcomes or goals.

The consumer utilizes the cash value benefit at any participating retail store or division of the retail store. The cash value benefit is presented to a customer service representative at a point of sale terminal as a form of payment for merchandise. The customer service representative may request identification, upon which the consumer can present the program identification card.

To summarize some embodiments, a retail store identifies a plurality of consumers to participate in a marketing incentive program. The consumers can be the most-valued consumers or the retail store can select the consumers randomly or by using any other method. The retail store provides the consumers with a benefit, such as a recurring cash value benefit. The benefit can also encompass any number of things, such as, for example, coupons, gift certificates, invitations to special events, etc.

To summarize other embodiments, a retail store determines the effectiveness of a marketing incentive. The retail store identifies a plurality of consumers to participate in a marketing incentive program. The retail store splits the consumers into a plurality of subsets, and distributes a different marketing incentive to each subset. After a period of time, the retail store analyzes which marketing incentive was the most effective. The marketing incentive can be a recurring cash value benefit or any other benefit.

To summarize additional embodiments, a retail store treats a consumer like an employee of the retail store. The consumer is selected by the retail store using any method and is given a benefit similar to a benefit that an employee of the retail store may receive.

The embodiments of the invention are useful because they provide a method and system for companies to provide marketing incentives to consumers. The marketing incentives enhance consumer loyalty to a particular company and suggests to the company that it maintain and/or improve services and products. The marketing incentives also make consumers happy to spend money in the company (e.g., retail store) and overall boosts the economy.

The embodiments described above are presented by way of example only and are not intended as a limitation upon the concepts and principles of the present invention. As such, it will be appreciated by one having ordinary skill in the art that various changes in the methods of providing consumer benefits are possible without departing from the spirit and scope of the present invention. Various features and aspects of the invention are set forth in the following claims.

1-61. (canceled)

62. A method of determining the effectiveness of a marketing incentive, the method comprising:
selecting a plurality of consumers;
selecting a first subset of the plurality of consumers and providing an incentive in the form of a recurring cash value benefit to the consumers in the first subset;
selecting a second subset of the plurality of consumers and providing to the consumers in the second subset an incentive different than the recurring cash value benefit; and
analyzing, after a predetermined amount of time, a behavior of the consumers in the first and second subsets to determine which incentive is effective.
